(19) United States
(12) Patent Application Publication
(10) Pub. No.: US 2016/0149539 A1
(43) Pub. Date: May 26, 2016

(54) Cable Module for Module Inverter of a Photovoltaic Generator

(71) Applicant: PHOENIX CONTACT GMBH & CO. KG, Blomberg (DE)

(72) Inventors: Jens Franke, Bad Pyrmont (DE); Andreas Beck, Polle (DE)

(21) Appl. No.: 14/897,992

(22) PCT Filed: Jun. 12, 2014
(86) PCT No.: PCT/EP2014/062293

§ 371 Date: Dec. 11, 2015

(30) Foreign Application Priority Data
Jun. 14, 2013 (DE) 10 2013 106 255.5

(51) Int. Cl. H02S 40/34; H01R 43/26; H01R 33/90; H02S 40/32; H02S 40/36

(52) U.S. Cl. CPC H02S 40/34; H02S 40/32; H02S 40/36; H01R 33/90; H01R 43/26

(57) ABSTRACT

The disclosure relates to alternating-current cabling for a photovoltaic generator having a plurality of photovoltaic modules equipped with module inverters. The alternating-current cabling comprises an alternating-current trunk line and branch cables connected thereto for feeding the alternating current from the plurality of module inverters into the common alternating-current trunk line, such that the alternating-current trunk line can be routed at a distance from the module inverters, and is composed of a plurality of pre-assembled cable modules. The pre-assembled cable modules each comprise the following components: a first and a second trunk-line plug connector; a trunk-line cable segment that connects the first and second trunkline plug connectors; and a branch cable electrically connected to the trunk-line cable segment.

### FIELD OF THE INVENTION

The invention relates to a cable module for electrically connecting module inverters of photovoltaic solar modules to an alternating current grid, and to a related method.

### BACKGROUND OF THE INVENTION

The field of photovoltaic generators which typically generate electric power by means of silicon-based semiconductors is subject to continuous development efforts. Although it is known for decades to use photovoltaic solar modules to generate electricity, the most suitable areas have already been almost fully exploited, especially in Central European locations.

Most suitable areas for this purpose are distinguished by the fact to face south to the best possible extent, to allow for an installation angle of the solar modules of approximately 35° relative to the ground, and that the area and hence the solar modules are not shaded in the diurnal cycle of the sun. Under these conditions a photovoltaic generator can achieve optimum electrical power output. Often, house roofs or other roof surfaces which have a typical roof pitch just in the range of the optimum installation angle or at least close to it are used for this purpose.

A far greater number of areas exist, which could in principle also be used as a surface for a photovoltaic generator. For opening up further areas, considerable problems will be posed by possible shading which is caused, for example, by roof structures or surrounding shadow casting objects such as trees, tall buildings, or industrial plants.

In classical photovoltaic generators, individual photovoltaic (PV) modules are connected in series to form a string, so that their voltages add. Depending on the system size, one or more strings are led to a string inverter, which transforms the direct current generated into alternating current compliant to the public power supply network.

Problems may be caused by the series connection, especially in case of shading. Shading of a single PV module or even of a single cell of a PV module has an impact on the output of the entire string. Only a few leaves scattered on the PV modules may already suffice to reduce the output of a PV generator. Certain roof structures such as dormers and chimneys will likewise reliably reduce the output by temporarily casting shadows on PV modules.

Security mechanisms, on the other hand, such as bypass diodes typically provided in the junction boxes which are mounted on the back of the PV modules often only give a false sense of security. Indeed, bypass diodes conduct the current of the unshaded modules of the string around the “bottleneck” of the shaded area, so in principle offering protection against dangerous hot spots. However, only very rarely these bypass diodes will be adapted to compensate for permanent or recurrent shading throughout the entire life cycle of a PV module. The result is often a failure of the bypass diode due to overload, and therefore again a reduction in the output of the entire string.

Therefore, surface areas for which temporal shading is known or has to be expected are usually omitted from being covered by PV modules, or selected ones of the PV modules that are expected to be similarly affected by shading are connected together to specific strings.

A known way to reduce the extent of the problem is to connect the PV modules only in parallel or only substantially in parallel to each other, i.e. not to form any strings of series connected PV modules. In this case it is no longer the voltages which add up, but the currents of the system, leading to a direct current connection of individual modules. However, since the result of high currents and low voltages is increased transmission loss, the purely parallel connection of PV modules is only rarely used, if at all, with the exception of very small systems, such as on mobile homes.

A comparatively recent way to solve the mentioned problems is the use of module inverters. In this case, a small module inverter, sometimes referred to as micro-inverter is installed near each PV module, which is dimensioned in terms of maximum power consumption to be just capable to transform the power of one or a few, e.g. two, PV modules.

This permits to use inexpensive and smaller components which may achieve a further improvement in efficiency.

By using module inverters, PV modules become independent of each other, so that each photovoltaic module may permanently be operated at its optimum operating point. Therefore, areas which are periodically shaded will no longer affect the power output of the rest of the PV modules of the same string, so that unshaded PV modules are no longer affected by shaded PV modules. At the same time, the power output obtained is better than with a DC connection of individual modules.

However, the wiring of the PV modules is now subject to new challenges, since the interconnection of an alternating current PV network is fundamentally different from the interconnection of a direct current PV network.

### SUMMARY OF THE INVENTION

Therefore, an object of the invention is to provide for wiring photovoltaic module inverters to an alternating current grid while achieving particularly low loss of the electric cabling system.

Another object of the invention is to provide an inexpensive cabling system.

Yet another object of the invention is to provide cabling in a manner so that the PV modules are easily stacked in their delivery state.

The object of the invention is achieved by the subject matter of the independent claims. Advantageous embodiments of the invention are specified in the dependent claims.

According to the invention, a photovoltaic generator comprises a plurality of photovoltaic modules equipped with module inverters, and an alternating current cabling system for delivering the electrical power output from the module inverters.

According to the invention, the alternating current cabling system of a single PV module comprises an alternating current (AC) trunk line, and connected thereto a drop cable for feeding the alternating current from the plurality of module inverters into the common AC trunk line.

Thus, the AC trunk line is the collecting main line into which the individual photovoltaic modules feed their power output through the module inverters and via the drop cable. This main line may extend along the entire photovoltaic generator or only along a portion thereof, and may consist of a plurality of preferably similar pre-assembled cable modules. This main or collecting line is therefore conveying the power generated in the PV modules to the electrical grid connection.

The pre-assembled cable modules comprise a first and, opposite the first, a second trunk line connector for alternating current, to each of which a further cable module of an adjacent PV module can be connected.

Further, the cable modules have a trunk line cable section connecting the first and second trunk line connectors, which spaces the first trunk line connector from the second trunk line connector of the cable module, in particular to allow for easy connection to the respective adjacent PV module.

In other words, the cable modules are interconnected by means of their first and second trunk line connectors to form a serially connected alternating current chain, so that the trunk line cable sections serially connected in this manner form the AC trunk line. In other words, the interconnected trunk line connectors together with the trunk line cable sections define the collection line of the PV generator or PV sub-generator.

The cable modules comprise a drop cable which is electrically connected to the trunk line cable section and thus to the AC trunk line in the interconnected state. The drop cable allows the AC trunk line to be installed spaced from the module inverters or associated PV modules. In other words, the drop cable permits a rather free installation of the AC trunk line.

Each of the module inverters has one cable module including a drop cable associated therewith, so that the module inverters are connectable to the AC trunk line by means of the respective associated drop cable, and on the other hand there are no excess and hence free drop cable ends remaining at the installation site.

A first end of each of the drop cables may be directly connected and fixed to one of the first or second trunk line connectors of the associated cable module. Preferably, the fixed connection is pre-assembled and cannot be released nondestructively. In other words, either the first trunk line connector or the second trunk line connector together with the trunk line cable section and the drop cable are delivered as a hardwired and assembled unit. Advantageously, the entire alternating current cabling system for connecting the PV modules to each other and possibly to the one or more inverter(s) is assembled merely by mating the first and second trunk line connectors with each other, without any other components. The hardwired units including the (first or second) trunk line connector, trunk line cable section, and drop cable are therefore modularly mateable trunk line portions, and a plurality of these hardwired units together form the trunk line.

Preferably, the drop cable is an at least two-pole or two-wire cable, more preferably a three-, or a five-wire cable according to the usual single-phase or three-phase electrical grids (three-wire corresponding to an ordinary household electrical grid, five-wire to a high voltage electrical grid). Preferably, drop cable and AC trunk line are similarly wired, that is to say they have the same number of electrical wires.

Preferably, the first and second trunk line connectors have metal terminal connectors which are interengaged with respective complementary metal terminal connectors of the mating complementary trunk line connector of the immediately adjacent cable module in the chain. These may for example be metal pin terminals and complementary metal socket terminals.

In particular, the wire ends of the individual electrical wires of the trunk line cable section and of the drop cable are directly connected to the respective metal terminal connector, e.g. crimped, soldered, or welded thereto.

In other words, the wires of the drop cable are introduced into the first or second trunk line connector and directly connected therein to the terminal contact of the respective wire, together with the respective wire of the trunk line cable section. Particularly advantageously, by directly connecting the wires within the trunk line connector, other costly and area-consuming components are eliminated, together with their respective electrical contact resistances.

Preferably, the wire cross section of the trunk line cable sections is considerably larger than the wire cross section of the drop cables. For example, the wires of the trunk line cable sections may have a cross-sectional area of about 4 mm², and the wires of the drop cable may have a cross-sectional area of about 0.75 mm².

The first and second trunk line connectors have housings which accommodate the metal terminal connectors, the wire ends of the respective trunk line cable section and of the respective drop cable, and which are in particular made of dielectric material. Furthermore, the housings of the first and second trunk line connectors may be sealed internally with an insulating sealing compound, and in case of the trunk line connector without drop cable the sealing compound encloses the end portion of the trunk line cable section, i.e. in particular the exposed wire end portions thereof. In case of the trunk line connector with directly connected drop cable, the sealing compound may enclose the end portions of the trunk line cable section and of the drop cable, i.e. in particular the respective wire end portions. This provides a particularly good protection against electric shock, and the exposed wires are decoupled from the humidity of the ambient air. In addition, the sealing compound improves low-temperature impact strength according to the UL 1703-30 standard.

The trunk line connectors preferably have a plug-in face. The plug-in face allows the trunk line connectors to be interengaged with the mating complementary trunk line connector of the immediately adjacent cable module in the chain, and the trunk line connector with directly connected drop cable has the trunk line cable section and the drop cable both entering into the housing of the trunk line connector in parallel to each other at the end opposite the plug-in face. In other words, both the drop cable and the trunk line cable section preferably enter the trunk line connector at the same side of the housing, so that all wires run in parallel to each other.

Preferably, the drop cable and the trunk line cable section enter the respective housing through two separate rear openings, and each are sealed in the respective rear opening by means of an annular seal.

The AC trunk line and the drop cables preferably have at least three, or four or five wires, and the trunk line connectors have at least three, or four or five metal terminal connectors. Particularly preferably, the metal terminal connectors are arranged side by side in a single plane, resulting in a very flat design. By virtue of the flat design it is possible to provide the trunk line connector in this manner below the PV module even during shipping, so that the space between the PV modules need not be increased because of the trunk line connectors.

That means, the dimension of the housings of the trunk line connectors therefore is considerably larger in width than in height, so that they have a flat shape. In particular, the width of the housings is at least 30 mm, and the height of the housings is not more than 20 mm.

The AC trunk line and the drop cables are each preferably adapted for conveying a single-phase alternating current, i.e. they have a single-phase configuration including three wires, namely phase, ground, and protective earth, or for conveying a polyphase alternating current, also known as three-phase alternating current, and in the latter case they will include at least four, more preferably five individual wires. The trunk line connectors accordingly will have three, or four or five metal terminal connectors electrically separated from each other.

The protective earth is preferably disposed between phase and ground, more preferably it is arranged centrally in the plug-in face thereby providing an anti-tilt feature. Most preferably, the protective earth is arranged so as to form a first make-last break contact, which means it protrudes a little more than phase and ground thereby providing for an increase in safety by the fact that always the protective earth is connected first, before phase and ground can make contact. In other words, when the connectors are mated the first make-last break contact will always make contact first, and when the connectors are pulled apart the first make-last break contact will always break the contact the last to reliably ensure protection and to remove potential differences before phase makes contact.

The cable modules are preferably pre-assembled in a manner so that the wire end portions of the drop cable opposite the cable end connected to the trunk line connector are hardwired to the associated module inverter or fixed in a plug-in connector for being plugged to a complementary connector of the module inverter, e.g. crimped, soldered, or welded thereto. In other words, particularly preferably the drop cables are connected to the module inverter of the PV module, i.e. hardwired or releasably connected by means of a connector, already before the latter is mounted on the roof, so that the PV module can be installed as a unit and hence much faster.

Furthermore preferably, the module inverter is likewise designed in a manner so that it can be mounted directly to the frame of the PV module without demanding additional installation height, so that the PV module is easily installed in the field as a unit, together with the module inverter and the cable module hardwired or detachably plugged thereto, so that no additional time is needed for establishing the electrical connections.

Moreover preferably, the first trunk line connector of the cable modules is formed as a male connector, and the second trunk line connector of the cable modules is formed as a female connector complementarily mateable therewith, or vice versa. In other words, the first trunk line connector is a pin connector and the second trunk line connector is a complementary socket connector engageable therewith, so that a chain of any desired length can be formed by concatenating any desired number of similar cable modules.

Furthermore, the first trunk line connector of the grid side terminal cable module of the AC trunk line is connectable to the electrical grid or to an adapter cable leading to the electrical grid and having a grid connector.

The second trunk line connector of the terminal cable module at the end of the AC trunk line opposite the grid side terminal cable module remains “blind”, i.e. not connected. This trunk line connector is preferably covered by a splash-proof end cap which seals the metal terminal connectors of the blind trunk line connector.

The first trunk line connectors may have locking tabs which are latched with corresponding locking projections of the respective mating second trunk line connector of the adjacent cable module, or vice versa, in order to lock the interconnection between the cable modules in the chain. Preferably, the locking projections and locking tabs are arranged laterally on the trunk line connector, in other words in a common plane with the metal terminal contacts of the trunk line connector, so that the installation height of the trunk line connector will still not be enlarged, even not by the locking mechanism.

The end cap may also have locking tabs or locking projections corresponding to these locking projections or locking tabs, by means of which the end cap is latched to the blind trunk line connector of the AC trunk line. This ensures that the end cap is likewise reliably latched to the trunk line connector and possibly cannot be released without the help of a skilled person.

Furthermore, the end cap may have a seal for splash-proof sealing of the blind trunk line connector of the AC trunk line.

Further, in addition to the locking projections, security projections may be arranged on the housing behind the locking projections as seen in the mating direction, that is to say perpendicular to the common plane of the locking projections and the metal terminal connectors, for impeding or even preventing inadvertent opening of the locking engagement.

Each of the housings may comprise a dielectric outer housing and a dielectric terminal holder disposed within the outer housing, in which the respective metal terminal connectors are fixed. The terminal holder may be sealed by a terminal holder gasket, so that the interior of the housing is protected from moisture penetrating through the plug-in face.

Furthermore, the housings may have a shock protection sleeve for each of the metal terminal connectors which accommodate the conductive metal terminal connectors. The housings of the first and/or the second trunk line connector may additionally have a sealing collar surrounding all the shock protection sleeves together.

In this case, the shock protection sleeves of the first and second trunk line connectors are preferably complementarily engageable, and either the sealing collar of the first trunk line connector engages into the opening of the second trunk line connector, or if both connectors are provided with sealing collars, the sealing collars complementarily engage each other.

At least one of the sealing collars of the first and second trunk line connectors may comprise a circumferential annular seal for sealing against the sealing collar of the complementary trunk line connector.

The wiring of the AC end of a plurality of photovoltaic modules equipped with module inverters typically comprises the following steps:

First, the PV modules are equipped with a cable module as described above. Preferably, each of the PV modules is additionally already equipped with a module inverter, so that the drop cables of the cable modules may be either hardwired to the respective module inverter or releasably connected thereto by means of a connector already prior to delivery. The respective module inverter may furthermore directly be connected to the junction box of the PV module at the DC end.

In their delivery state, the cable modules are provided with easily releasable shipping caps at both trunk line connectors. The PV modules equipped in this manner, i.e. particularly advantageously together with the cable modules, are delivered to the installation site of the photovoltaic generator.

In the next step the PV modules are mounted at the installation site, and the protective caps are removed from the cable modules not yet mated. The cable modules not yet mated are then interconnected and thereby form the common AC trunk line. Finally, the blind trunk line connector is closed by a sealing end cap, and the AC trunk line, preferably the proximal end thereof, is connected to the electrical grid by means of a grid connector.

Alternatively, it is also possible for the PV modules to be delivered to the installation site of the photovoltaic generator without module inverter and without cable modules. In this case, first the drop cables of the cable modules are connected to the module inverters at the installation site, and then the shipping caps are removed from the cable modules not yet mated. The cable modules not yet interconnected are then interconnected, and the blind trunk line connector of the AC trunk line is closed with the corresponding end cap. Finally, the AC trunk line is connected to the electrical grid using a grid connector.

A photovoltaic generator according to the invention thus includes a plurality of PV modules, at least some of which have a module inverter, and the module inverters are wired using the alternating current cabling system described above and are connected to the electrical grid.

According to the invention, a kit of pluggable cable components for on-site interconnection of the alternating current cabling system of a photovoltaic generator that comprises a plurality of photovoltaic modules equipped with module inverters comprises a plurality of similar, pre-assembled cable modules. The cable modules, in turn, each include a male and a female trunk line connector, a trunk line cable section connecting the male and female trunk line connectors, and a drop cable electrically connected to the trunk line cable section, and any number of cable modules can be plugged together serially to form a chain of any desired length, so that the trunk line cable sections serially connected in this manner together form the AC trunk line, and so that the module inverters are connected to the AC trunk line by the respectively associated drop cable, and wherein the drop cables are directly connected and hardwired to one of the first or second trunk line connectors of the associated cable module, i.e. cannot be detached nondestructively.

The kit of pluggable cable components further comprises, for each AC trunk line to be plugged together, a male end cap which can be fitted to the female trunk line connector, or a female end cap which can be fitted on the male trunk line connector, to seal it during operation of the photovoltaic generator.

In addition to the end caps, the kit may further comprise a male shipping cap which can be fitted to the female trunk line connector, and a female shipping cap which can be fitted to the male trunk line connector to close it during shipping.

For the locking tabs of the first trunk line connector, which are optionally provided and which are latchable with corresponding locking projections of the respective mating second trunk line connector, or vice versa, the modular connector system may comprise a release tool by means of which the locking engagement can be released.

The shipping caps may be adapted to be manually removable from the trunk line connectors without a special tool. The male and female end caps may likewise have locking tabs and locking projections which are latchable with the corresponding locking projections or locking tabs of the corresponding trunk line connector, and the locking engagement may be releasable using the release tool, optionally even only when using the release tool.

Furthermore, a kit comprising mateable male and female photovoltaic connectors and a release tool is provided.

Here, the male and female photovoltaic connectors each comprise a dielectric housing having a plug-in face with metal terminal contacts for mating interconnection with the complementary metal terminal contacts of the complementary photovoltaic connector, and the dielectric housing of one of the pair of male and female connectors has a locking projection on either lateral side of the plug-in face.

The dielectric housing of the complementary photovoltaic connector has a locking tab on either lateral side of the plug-in face, which is latchable with the locking projection in order to lock the interconnection between the male and female photovoltaic connectors in their mated state.

The dielectric housing of the male or female photovoltaic connector may further have a groove extending transversely to the mating direction at a lateral side behind the locking projection or the locking tab.

The release tool is substantially U-shaped having two side flanks and a base connecting the two side flanks, wherein the two side flanks of the release tool have an release post extending away from the base transversely thereto. Thus, the release tool can be fitted to the mated and latched male and female photovoltaic connectors transversely to the mating direction. In the fitted state, the release post will be placed between the respective locking tab and a housing portion, the release post thereby biasing the respective locking tab away from the complementary locking projection, so that the locking engagement of the interconnection between the male and female photovoltaic connectors is released to an extent that allows the two mated photovoltaic connectors to be pulled apart manually. In other words, the release post of the release tool urges the locking tab away from the complementary locking projection so that the latching engagement is almost or completely released and the photovoltaic connectors can be pulled apart.

The release posts of the release tool and the housing of the male or female photovoltaic connector have mutually complementary latching means by means of which the release tool is latched so that the release tool is retained at the photovoltaic connector. In other words, the latching means are adapted to retain the release tool on one of the two photovoltaic connectors, so that, advantageously, the release tool does not need to be hold, in particular when pulling apart the two mated photovoltaic connectors. This is particularly useful when during inspection or replacement work on a roof, connections of the photovoltaic connectors have to be released and the release tool can remain fixed on the photovoltaic connector until appropriate measures can be taken to remove the release tool.

The complementary latching means are defined by a groove on the release post extending transversely to the release post on the one hand, and on the other by a bead on the housing of one of the photovoltaic connectors, which also extends transversely to the release post, or in the mating direction of the photovoltaic connector. Groove and complementary bead may also be provided vice versa, i.e. with the groove on the housing and the bead on the release post.

The cable module which comprises a first and a second trunk line connector, a trunk line cable section connecting the first and second trunk line connectors, and a drop cable electrically connected to the trunk line cable section, may be serially connected with further cable modules by means of the first and second trunk line connectors to form a chain. The trunk line cable sections serially connected in this manner will then together form the AC trunk line. By means of the drop cable, a module inverter of a photovoltaic module is connectable to the AC trunk line, and the drop cable is directly connected and hardwired to one of the first or second trunk line connectors of the cable module with at least three electrical wires. Further, the other wire end of the drop cable is directly connected and hardwired to the module inverter with three wires.

The corresponding photovoltaic module comprises a peripheral stabilizing frame arranged at the back which faces away from the sun, and a connection and junction box mounted to the back. A flat module inverter electrically connected to the connection and junction box is mounted to the back of the photovoltaic module, for transforming the electric direct current of the photovoltaic module into electric alternating current. A cable module is hardwired to the module inverter with three wires.

Here, the module inverter has an installation height that does not extend beyond the peripheral stabilizing frame, so that the back-side installation components of the photovoltaic module as a whole do not project beyond the peripheral stabilizing frame.

The invention will now be explained in more detail by way of exemplary embodiments and with reference to the figures in which identical and similar elements are partly provided with the same reference numerals, and wherein the features of the different exemplary embodiments can be combined.

### BRIEF DESCRIPTION OF THE FIGURES

In the drawings:

FIG. 1 is a schematic diagram of an alternating current cabling system of a photovoltaic generator;

FIG. 2 is another schematic diagram of an alternating current cabling system of a photovoltaic generator;

FIG. 3 shows a first sectional view of a cable module;

FIG. 4 is a sectional view of a female plug-in face;

FIG. 4a is a plan view of a female plug-in face;

FIG. 5 is a sectional view of a male plug-in face;

FIG. 6 is a sectional view of the female and male connectors;

FIG. 7 shows a shipping cap;

FIG. 8 shows another shipping cap;

FIG. 9 shows an end cap;

FIG. 10 shows another end cap;

FIG. 11 is a schematic perspective view of a release tool;

FIG. 12 is another perspective view of a release tool;

FIG. 13 shows first and second photovoltaic connectors;

FIG. 14 is a perspective view of first and second photovoltaic connectors;

FIG. 15 shows a kit for assembling an alternating current cabling system;

FIG. 16 shows another composition of a kit for assembling an alternating current cabling system.

### DETAILED DESCRIPTION OF THE FIGURES

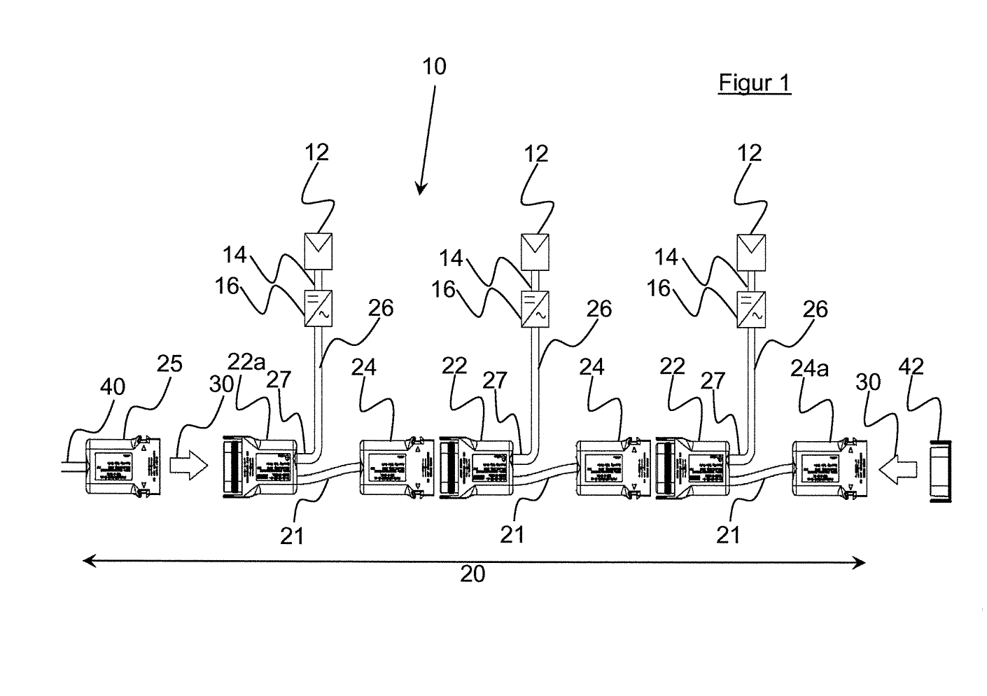

FIG. 1 shows a schematic diagram of the components of an alternating current cabling system according to the invention for a photovoltaic generator 10.

Photovoltaic generator 10 comprises a plurality of photovoltaic (PV) modules 12 each of which has a module inverter 16 connected thereto. Each of the module inverters 16 is connected to a connection and junction box (not shown) of the PV modules 12 mounted to the back thereof, with two direct current cables 14.

Each of the module inverters 16 is electrically connected to the alternating current (AC) trunk line 20, via a respective drop cable 26 associated with a respective one of the photovoltaic modules 12, by having one end 27 of the drop cable 26 directly extending into the first trunk line connector 22 and the wires thereof making electrical contact therein. At the same place inside the first trunk line connector 22, the wires of trunk line cable section 21 are electrically connected (see FIGS. 3, 4, 5, and 6), so that the wires of drop cable 26 and the wires of trunk line cable section 21 are connected to common cable connections within first trunk line connector 22. Trunk line cable sections 21 connect the first trunk line connector 22 to the respective second trunk line connector 24. The first and second trunk line connectors 22, 24 can be connected or mated with the second and first trunk line connectors 24, 22, respectively, of an adjacent photovoltaic module 12, with arrow 30 indicating the related mating direction.

The grid side terminal cable module of AC trunk line 20 is connected to an adapter cable 40, by its first trunk line connector 22a and by means of an adapter plug 25.

The terminal cable module at the end of AC trunk line 20 opposite to the grid side terminal cable module remains blind and is provided with an end cap 42 which seals the blind trunk line connector 24a.

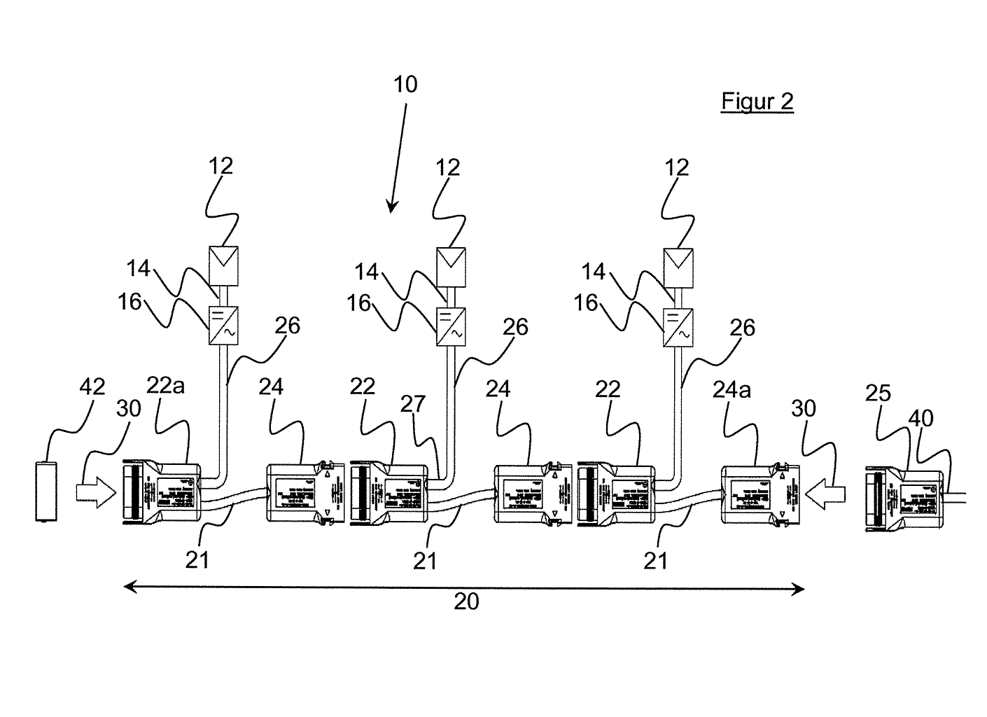

FIG. 2 shows another embodiment of an alternating current cabling system of a photovoltaic generator 10, in which the AC trunk line 20 is connected at its other end, via adapter plug 25, to the adapter cable 40 which leads to the electrical grid.

FIG. 3 is a first sectional view through cable module 8. First trunk line connector 22 is connected to second trunk line connector 24 via trunk line cable section 21. The entry openings for the cables in each of the connectors are protected against ingress of dust and moisture by cable seals or annular seals 50. Thus, a separate annular sealing 50 is provided for each of the two ends of trunk line cable section 21 inserted into first trunk line connector 22 and second trunk line connector 24, respectively, and for the first end 27 of drop cable 26 inserted into trunk line connector 22. Furthermore, the cables are retained in the connector by strain relief sleeves 52.

First and second trunk line connectors 22, 24 comprise a connector housing 32 which is made of dielectric material, i.e. is a molded plastic part. Each of the connector housings 32 has a front side opening for the plug-in face.

In this embodiment, latching or locking tabs 56 are provided on first trunk line connector 22 along both sides of connector housing 32, which engage with locking projections or latching hooks 54 to reliably latch the first and second trunk line connectors 22, 24 with each other in their mated state.

Behind latching hook 54 as seen in the mating direction, a security projection 58 is arranged on each lateral side of connector housing 32, which impedes or prevents latching tab 56 locked behind latching projection 54 from accidental release.

Drop cable 26 is only shown in shortened form in FIG. 3, so that the second end 28 of the drop cable is illustrated as well. In the embodiment of FIG. 3, the drop cable includes three individual wires 29 which are considerably thinner here than the individual wires 19 of AC trunk line 20.

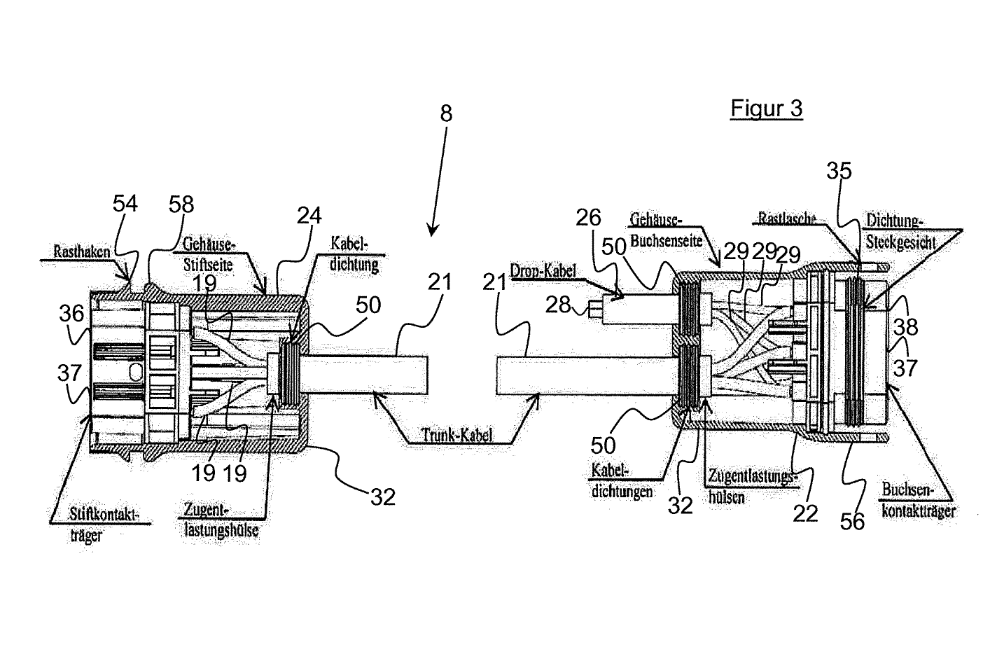

For accommodating the individual wires 19, 29, connector housing 32 includes pin terminals or socket terminals (see FIGS. 4 to 7) which are already pre-assembled in a pin terminal holder 36 or a socket terminal holder 38. Pin terminal holder 36 and socket terminal holder 38 are each projecting beyond the respective inside terminals so as to already fulfill the function of a protection against accidental contact. To further increase safety, a shock protection sleeve 37 is additionally arranged around pin terminal holder 36 and around socket terminal holder 38. A circumferential sealing collar 35 is fitted around socket terminal holder 38, which in the mated state is urged against the inner wall of pin contact holder 36 thereby ensuring sealing engagement.

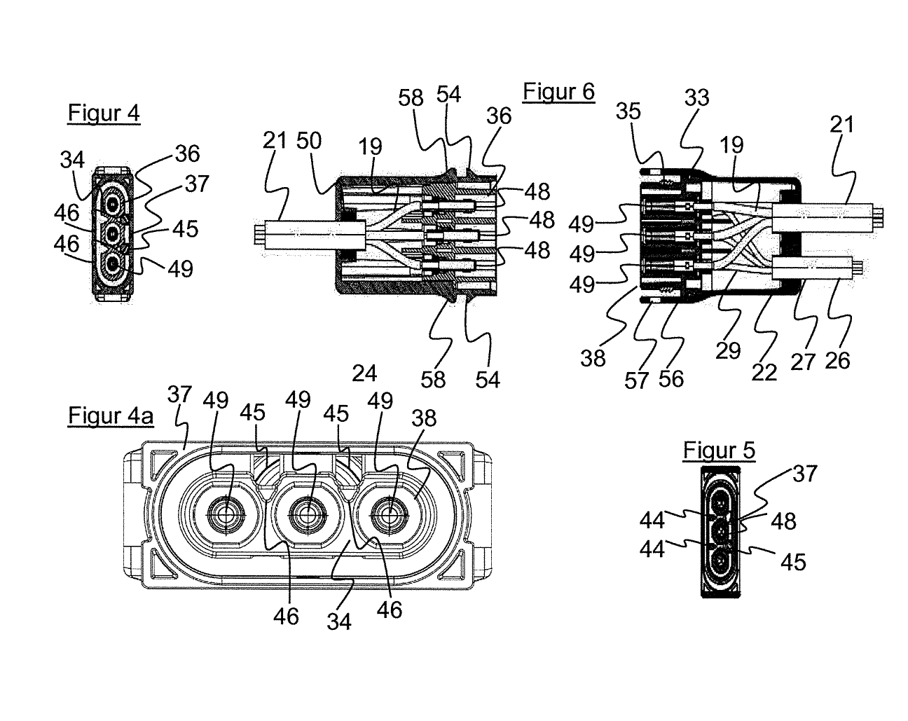

FIG. 4 shows a sectional view through the plug-in face 34 of the female trunk line connector which is the first trunk line connector 22 in the present embodiment. Plug-in face 34 is framed by a peripheral border, namely shock protection sleeve 37, and socket terminal holder 38 is ‘keyed’, i.e. it has a reverse polarity protection. The reverse polarity protection is implemented in form of reverse polarity protection notches 46 (see also FIG. 4a) into which reverse polarity protection ribs 44 will engage, which are arranged on the complementary connector (see FIG. 5). Reverse polarity protection notches 46 and reverse polarity protection ribs 44 are disposed on one side of socket terminal holder and pin terminal holder, respectively. Socket terminals 49 for receiving the metal pin terminals 48 are arranged centrally in socket terminal holder 38. Further, holes 45 are additionally provided at one side of socket terminals 49, through which a sealing compound may be filled into the housing 32.

FIG. 4a shows a plan view of plug-in face 34 of the embodiment of FIG. 4. Socket terminals 49 are enclosed by socket terminal holder 38. Shock protection sleeve 37 is arranged around socket terminal holder 38 and projects beyond socket terminal holder 38 and socket terminals 49.

FIG. 5 is a sectional view through the plug-in face 34 of the male trunk line connector, i.e. the second trunk line connector 24 in this embodiment. The male plug-in face 34 is likewise surrounded by a shock protection sleeve 37 enclosing the metal pin terminals 48 which project in the mating direction. The reverse polarity protection of the male connector is provided on shock protection sleeve 37 by reverse polarity protection ribs 44 arranged thereon, which correspond to the reverse polarity protection notches 46 in the female connector (see FIG. 4), so that the connectors can only be mated with each other in exactly one orientation.

FIG. 6 shows a further sectional view through the female and the male connectors, i.e. first trunk line connector 22 and second trunk line connector 24 in the present example, the section being taken through pin terminal holder 36 and socket terminal holder 38. It will be apparent therefrom, that in the assembling process pin contact holder 36 and socket terminal holder 38 are inserted into the respective connector housing 32 from the front and sealed therein by means of terminal holder gasket 33. When the two plug-in faces 34 are mated, an additional sealing is provided by sealing collar 35. Also, metal pin terminals 48 are clearly visible in this view, and the central metal terminal which is connected to the protective earth wire is arranged as a first make-last break contact, i.e. it protrudes further than the other metal terminals 48. Socket terminals 49 are regularly arranged side by side within female trunk line connector 22.

First trunk line connector 22 has recesses 57 in locking tabs 56, into which locking projections 54 will engage so that a reliable locking engagement of the mated connectors is obtained. An inadvertent release is impeded by security projections 58 on second trunk line connector 24.

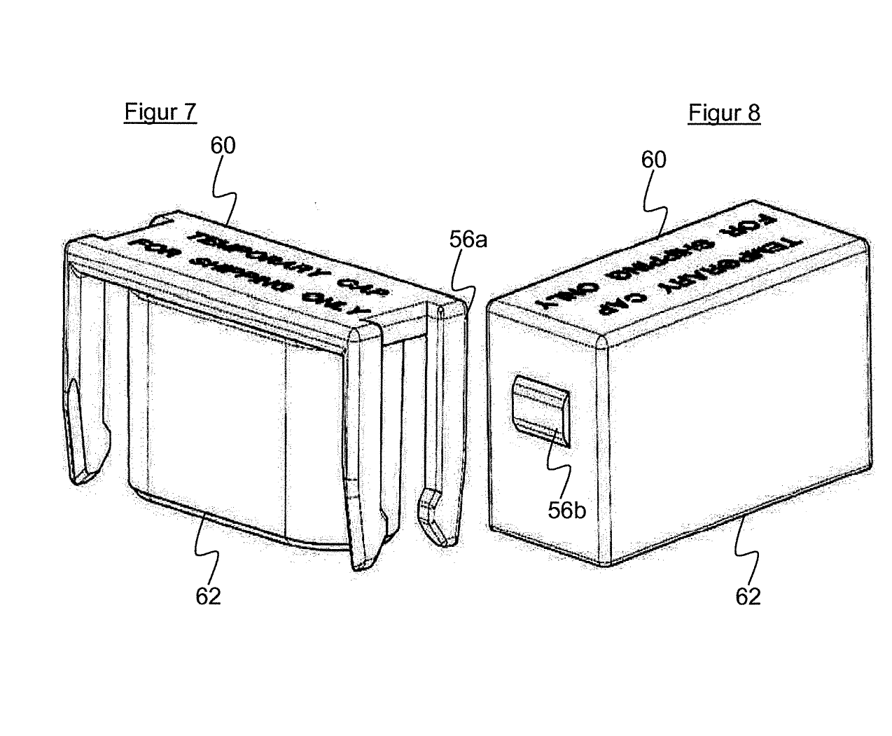

FIG. 7 shows an embodiment of a shipping cap 60 for closing the male, second trunk line connector 24 to provide additional protection against moisture and dust during shipping. Shipping cap 60 has an opening 62 on one end which can be fitted over the second trunk line connector.

Shipping cap 60 as shown in FIG. 7 can be released manually. This is made possible by the specific geometry of the two-part locking tab comprising two locking tab arms 56a. Locking tab arms 56a do not completely enclose latching hook 54 of the corresponding second trunk line connector 24 but embrace it laterally with rounded retaining hooks 56b. In other words, when fitting the shipping cap 60 to second trunk line connector 24, the two locking tab arms 56a will be deflected and will relax in the mated position, so that an exactly pre-determinable holding force is produced between second trunk line connector 24 and shipping cap 60, which is predefined by adjusting the shape of rounded retaining hooks 56b in a manner so that the shipping cap 60 can be removed manually.

FIG. 8 shows a shipping cap 60a which is adapted for closing the female connector, i.e. first trunk line connector 22 in this embodiment. Shipping cap 60a also has an opening 62 which can be fitted over the plug-in face 34 of the first trunk line connector 22.

Shipping cap 60a as shown in FIG. 8 has rounded locking projections 54a on either lateral side thereof. When the first trunk line connector 22 is mated with shipping cap 60a, the locking tab 56 of first trunk line connector 22 will be pushed over the rounded locking projections 54a, so that the rounded locking projections 54a will engage in recesses 57 of locking tabs 56 (see FIG. 6).

The holding force of shipping cap 60a on the first trunk line connector 22 is adjustable through the shape and angle of curvature of rounded locking projections 54a. The shape of rounded locking projections 54a is adapted so that the shipping cap 60a can be removed manually.

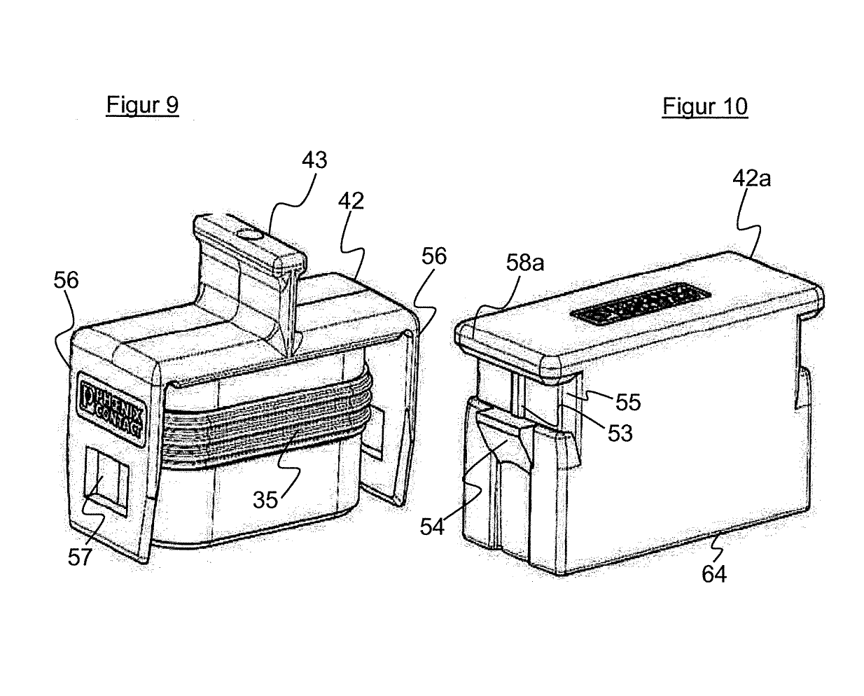

FIG. 9 shows an embodiment of an end cap 42 which can be plugged into second trunk line connector 24 for watertight sealing thereof. End cap 42 has a sealing collar 35 and particularly robust locking tabs 56. When mating the end cap 42 with the second trunk line connector 24, the locking projections 54 of the second trunk line connector 24 (see FIG. 3) will engage into recess 57 of locking tab 56 so that a reliable joint is established. The portion of locking tab 56 that extends beyond recess 57 will cover the area between locking projection 54 and security projection 58 thereby producing a surface as flush as possible, so that the locking tab 56 cannot be lifted from the housing 32 of the second trunk line connector 24 without further measures. In this manner, inadvertent release is effectively avoided.

The end cap 42 of the embodiment of FIG. 9 further includes a handle 43 which allows the end cap 42 to be easily guided with two fingers when being removed from the connector. In other words, handle 43 facilitates the handling of end cap 42 both when being installed and when being removed from the connector, in particular in difficult installation sites such as on rooftops.

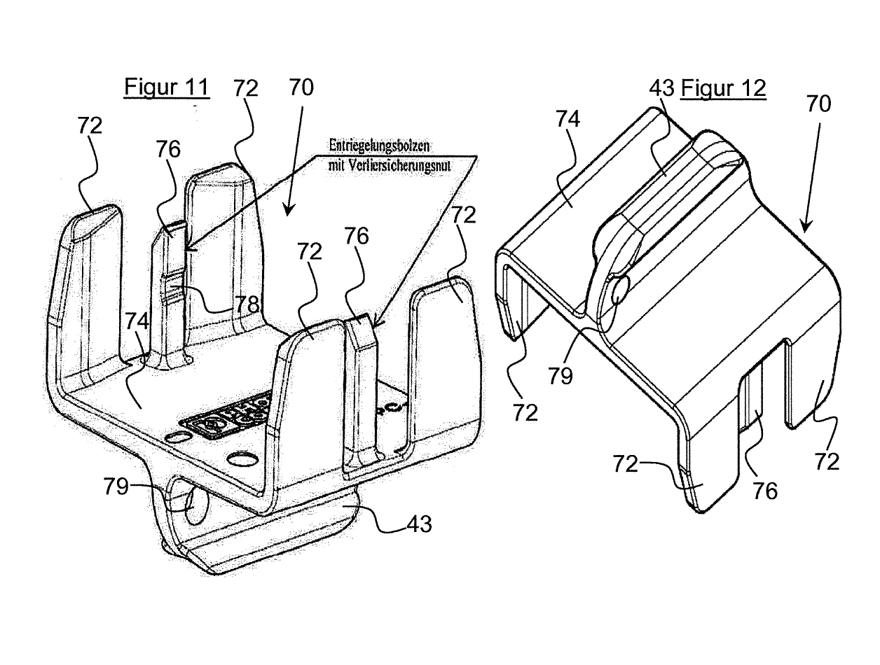

FIG. 10 shows an end cap 42a for watertight sealing of the first trunk line connector 22, wherein end cap 42a when being mated is fitted with its opening 64 over the plug-in face 34 of the first trunk line connector 22.

End cap 42a has locking projections or latching hooks 54 which are designed so that during mating the locking tabs 56 of the first trunk line connector 22 will slide over latching hooks 54 thereby being temporarily deflected, and in the mated position the protruding portion of locking tabs 56 will be disposed behind latching hooks 54 with the locking tabs 56 in a relaxed state, thereby enabling a latching engagement with a great holding power.

End cap 42a further has an overhang 58a at its end opposite opening 64, which adopts the function of security projection 58 by effectively preventing the locking engagement from being accidentally released.

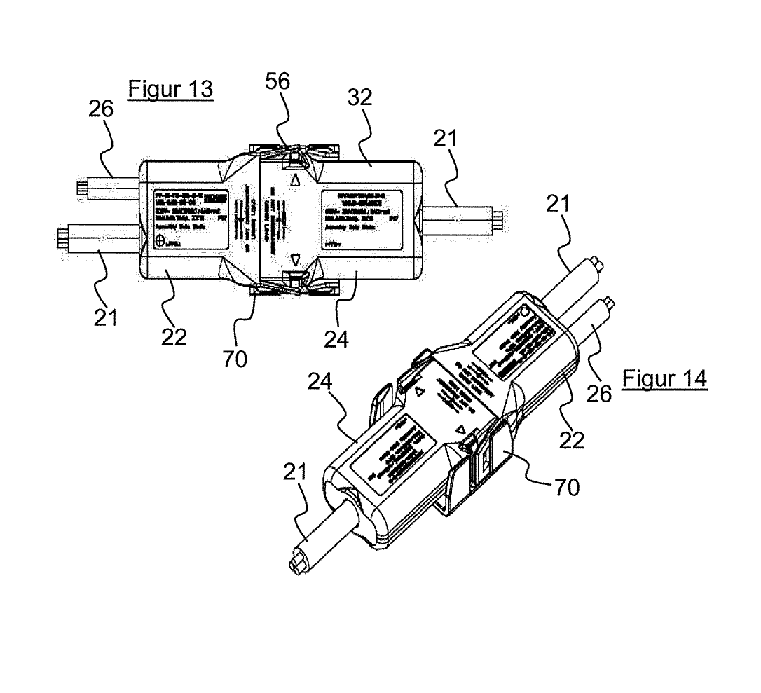

For introducing a release tool 70 (see FIGS. 11, 12), the end cap 42a further has a recess 55 on either lateral side thereof. A release post 76 of the release tool 70 can be introduced into recess 55 so that an overlying locking tab 56 is raised and thus the locking engagement is released. For easier insertion of the release post 76 of release tool 70, the recess 55 has rounded edges on all sides.

In addition, a bead 53 for locking the release tool 70 is provided centrally in recess 55, which bead extends in the insertion direction of the connectors and may engage in a retaining groove 78 (see FIGS. 11, 12) of release tool 70.

FIG. 11 is a schematic perspective view of a release tool 70 which is suitable for easily releasing the connectors, i.e. for example trunk line connectors 22, 24, but also end cap 42a connected to first trunk line connector 22, and more generally for first and second photovoltaic connectors 22b, 24b with the shape of trunk line connectors 22, 24.

Release tool 70 is substantially U-shaped and has four side flanks 72 in the present embodiment, and a base 74 connecting the side flanks 72. Side flanks 72 are arranged in pairs in parallel to each other and have a shape so that they can encompass the connector housing 32.

Furthermore, a release post 76 extends perpendicularly from base 74 at both sides thereof between side flanks 72 and slightly inwardly offset thereto. In other words, side flanks 72 and release post 76 both extend in the same direction. Release post 76 further has a retaining groove 78 by means of which the release tool 70 can be locked to connector 22, 22b, 24, 24b and end cap 42, so that the release tool 70 is clamped or latched to the connector.

Release post 76 can be inserted into recess 55 of end cap 42a mounted to a connector, so that release post 76 will raise locking tab 56 and thus release the locking engagement of the connector with end cap 42a.

Release tool 70 further has a handle 43 by means of which the release tool is easily held with two fingers and thus can be positioned more easily, i.e. attached or removed. In addition, handle 43 has an eyelet 79 into which a cord can be threaded, for example, by means of which the release tool 70 may be additionally attached in its unmated state, for example to a pair of pants or to a bunch of keys.

FIG. 12 shows another perspective view of release tool 70 with handle 43 and side flanks 72.

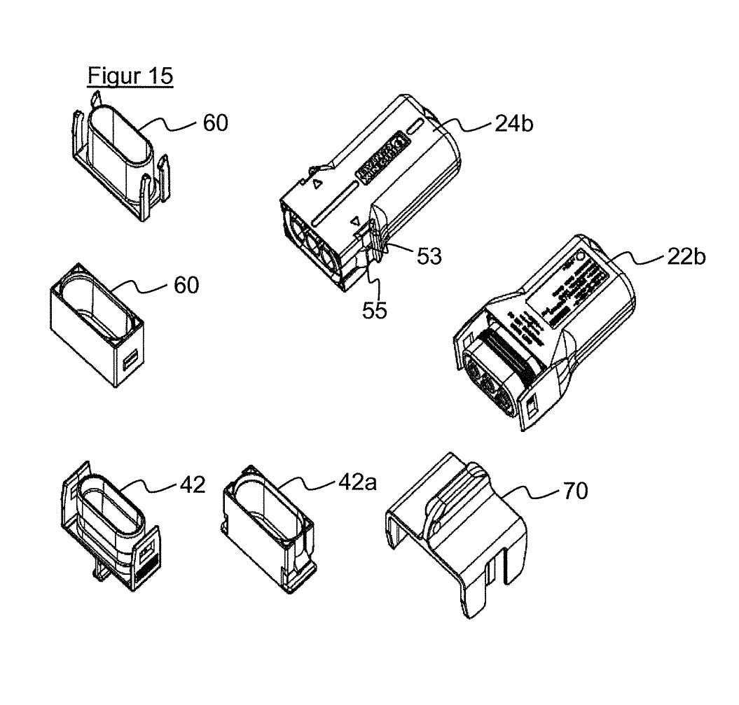

FIG. 13 finally shows a plan view of first and second photovoltaic connectors 22b, 24b in their mated state, and in addition a release tool 70 fitted at the lower side of second photovoltaic connector 24b. Release tool 70 biases locking tabs 56 apart, by means of release post 76, so that the locking engagement is released and the connectors can be pulled apart, i.e. disengaged.

FIG. 14 shows a further, perspective view of a second photovoltaic connector 24b mated with a first photovoltaic connector 22b, and with a release tool 70 latched to the lower side thereof.

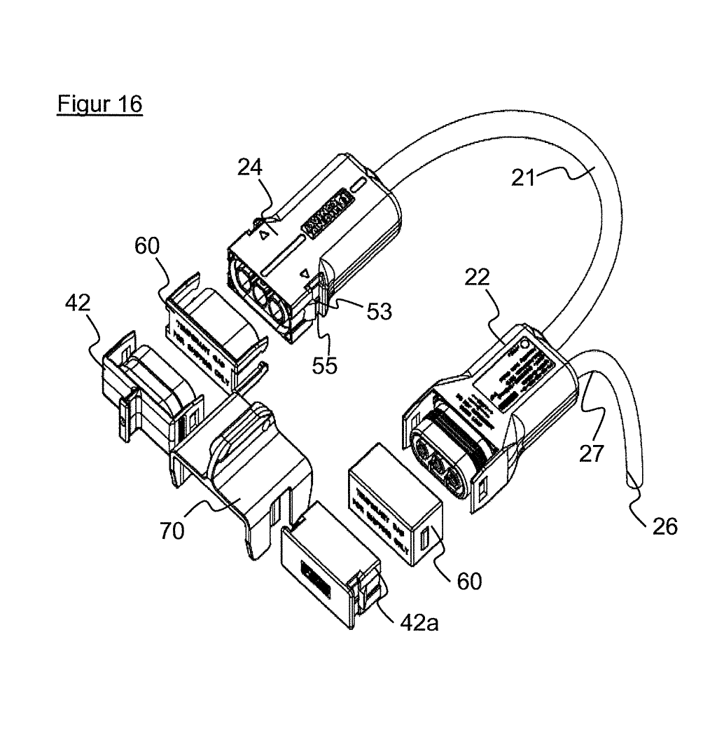

FIG. 15 shows an overview of the essential components of a kit for assembling an alternating current cabling system of a PV module, which comprises a first photovoltaic connector 22b and a second photovoltaic connector 24b mateable with the first one. Photovoltaic connectors 22b, 24b are covered by shipping caps 60 for transport, a terminal photovoltaic connector 22a, 24a can be sealed with an end cap 42, 42a. Release tool 70 may be used for opening the latching engagement between first and second photovoltaic connectors 22b, 24b as well as between connectors 22, 22b, 24, 24b and end caps 42, 42a.

In the embodiment of FIG. 15, lateral recess 55 and bead 53 are visible on photovoltaic connector 24b, which serve to receive release post 76 and retaining groove 78, respectively.

FIG. 16 shows a further composition of a kit for assembling an alternating current cabling system of a PV module, with the cables connected. In the embodiment of FIG. 16, a first trunk line connector 22 is connected to a second trunk line connector 24 through a trunk line cable section 21, and is further connected to the module inverter 16 of the PV module 12 via a drop cable 26. In their delivery state, trunk line connectors 22, 24 are temporarily covered by the shipping caps 60 as illustrated, and in case of a trunk line terminal connector 22a, 24a they may be sealed with an end cap 42, 42a. By means of release tool 70 the respective connections are easily unlocked and disengaged.

Also, recess 55 is visible on trunk line connector 24, into which the release post 76 of release tool 70 may be inserted. Bead 53 which engages in retaining groove 78 is likewise provided there.

It will be appreciated by those skilled in the art that the embodiments described above have only been set forth by way of example and that the invention is not limited thereto but may be varied in many ways without thereby departing from the scope of the invention. Furthermore, it will be appreciated that every feature which is disclosed in the description, the claims, the figures or otherwise can be an essential feature of the invention alone, irrespective whether it is described or shown together with other features.

### LIST OF REFERENCE NUMERALS

8 Cable module

10 Photovoltaic generator

12 Photovoltaic (PV) module

14 DC connection

16 Module Inverter

19 Individual wire of AC trunk line

20 AC trunk line

21 Trunk line cable section

22 First trunk line connector

22a First trunk line terminal connector

22b First photovoltaic connector

24 Second trunk line connector

24a Second trunk line terminal connector

24b Second photovoltaic connector

25 Adapter cable connector

26 Drop cable

27 First end of drop cable

28 Second end of drop cable

29 Individual wire of drop cable

30 Mating direction

32 Connector housing

33 Terminal holder gasket

34 Plug-in face

35 Sealing collar

36 Pin terminal holder

37 Shock protection sleeve

38 Socket terminal holder

40 Adapter cable for connection to the electrical grid

42 End cap

42a End cap

43 Handle

44 Reverse polarity protection rib

45 Holes

46 Reverse polarity protection notch

48 Metal pin terminal

49 Socket terminal

50 Annular or cable seal

52 Strain relief sleeve

53 Bead

54 Locking projection or latching hook

54a Rounded locking projection

55 Recess

56 Locking or latching tab

56a Locking tab arms

56b Rounded retaining hooks

57 Recess in locking tab

58 Security projection

58a Overhang

60 Shipping cap

60a Shipping cap

62 Opening of shipping cap

64 Opening of end cap

70 Release tool

72 Side flanks

74 Base

76 Release post

78 Retaining groove

79 Eyelet

1. An alternating current cabling system for a photovoltaic generator which comprises a plurality of photovoltaic modules equipped with module inverters, comprising an alternating current trunk line and drop cables connected thereto for feeding the alternating current from the plurality of module inverters into the common alternating current trunk line, so that the alternating current trunk line can be installed spaced from the module inverters, the alternating current cabling system being composed of a plurality of preassembled cable modules, each of the pre-assembled cable modules comprising the following components:
a first and a second trunk line connector;
a trunk line cable section connecting the first and second trunk line connectors; and
a drop cable electrically connected to the trunk line cable section;
wherein the cable modules are serially connected together by means of their first and second trunk line connectors to form a chain so that the trunk line cable sections serially connected in this manner form the alternating current trunk line;
wherein each of the module inverters has associated therewith a cable module including a drop cable, so that the module inverters are connectable to the alternating current trunk line by means of the respective associated drop cable; and
wherein one cable end of each of the drop cables is directly connected and hardwired to one of the first or second trunk line connectors of the associated cable module.

2. The alternating current cabling system as claimed in claim 1, wherein the first and second trunk line connectors comprise metal terminal connectors which are interengaged with respective complementary metal terminal connectors of the mating complementary trunk line connector of the immediately adjacent cable module in the chain, and wherein the wire ends of the individual electrical wires of the trunk line cable section and of the drop cable are connected to the respective metal terminal connector, in particular crimped, soldered, or welded thereto.

3. The alternating current cabling system as claimed in claim 1, wherein the wire cross section of the trunk line cable sections is considerably larger than the wire cross section of the drop cables.

4. The alternating current cabling system as claimed in claim 2, wherein the first and second trunk line connectors have housings which accommodate the metal terminal connectors, the wire ends of the respective trunk line cable section and of the respective drop cable, and which are sealed inside by an insulating sealing compound, wherein the sealing compound i) encloses the end portion of the trunk line cable section in case of the trunk line connector without drop cable; and ii) encloses the end portions of the trunk line cable section and of the drop cable in case of the trunk line connector with directly connected drop cable.

5. The alternating current cabling system as claimed in claim 1, wherein the trunk line connectors have a plug-in face by means of which they are plugged together with the mating complementary trunk line connector of the directly adjacent cable module in the chain, wherein in the trunk line connector with directly connected drop cable, both the trunk line cable section and the drop cable enter the housing of the trunk line connector in parallel to each other at the end opposite the plug-in face.

6. The alternating current cabling system as claimed in claim 5, wherein the drop cable and the trunk line cable section enter the respective housing through two separate rear openings and each are sealed in the respective rear opening by means of an annular seal.

7. The alternating current cabling system as claimed in claim 2, wherein the alternating current trunk line and the drop cables have at least three, or four or five wires, and the trunk line connectors have at least three, or four or five metal terminal connectors which are arranged side by side in a single plane.

8. The alternating current cabling system as claimed in claim 7, wherein the housings of the trunk line connectors have a flat shape, with a width of the housings of at least 30 mm and a height of the housings of not more than 20 mm.

9. The alternating current cabling system as claimed in claim 2, wherein both the alternating current trunk line and the drop cables have a single-phase configuration including three individual wires, namely phase, ground, and protective earth, or a polyphase configuration including at least four individual wires, and wherein the trunk line connectors correspondingly have three, or four or five metal terminal connectors.

10. The alternating current cabling system as claimed in claim 9, wherein the protective earth is arranged between phase and ground, and/or is arranged so as to form a first make-last break contact.

11. The alternating current cabling system as claimed in claim 1, wherein the cable modules are pre-assembled such that the wire end portions of the cable end of the drop cable opposite the cable end connected to the trunk line connector are hardwired to the associated module inverter or reliably connected in a connector for being plugged to a complementary connector of the module inverter.

12. The alternating current cabling system as claimed in claim 1, wherein the first trunk line connector of the cable modules is formed as a male connector and the second trunk line connector of the cable modules is formed as a female connector mateable therewith, or vice versa, so that a chain of any desired length can be formed by concatenating any number of similar cable modules; wherein the first trunk line connector of the terminal cable module of the alternating current trunk line is connectable to the electrical grid, or to an adapter cable leading to the electrical grid or having a grid connector; and wherein the second trunk line connector of the terminal cable module at the end of the alternating current trunk line opposite the grid side terminal cable module remains blind; and comprising an end cap which closes the blind trunk line connector.

13. The alternating current cabling system as claimed in claim 1, wherein the first trunk line connectors have locking tabs which are latched with corresponding locking projections of the respective mating second trunk line connector, or vice versa, in order to lock the interconnection between the cable modules in the chain.

14. The alternating current cabling system as claimed in claim 13, wherein the end cap has locking projections or locking tabs corresponding to the locking tabs and locking projections, respectively, by means of which the end cap is latched to the blind trunk line connector of the alternating current trunk line; and/or wherein the end cap has a seal for splash-proof sealing of the blind trunk line connector of the alternating current trunk line.

15. The alternating current cabling system as claimed claim 13, wherein the housing that includes the locking projections has security projections arranged behind the locking projections as seen in the mating direction.

16. The alternating current cabling system as claimed in claim 2, wherein each of the housings comprises a dielectric outer housing and a dielectric terminal holder disposed within the outer housing, in which the respective metal terminal connectors are fixed.

17. The alternating current cabling system as claimed in claim 1, wherein each of the housings has, at its plug-in face, a shock protection sleeve for each of the metal terminal connectors and a sealing collar enclosing the shock protection sleeves, wherein the shock protection sleeves of the first and second trunk line connectors are complementarily mateable and wherein the sealing collars of the first and second trunk line connectors are complementarily mateable.

18. The alternating current cabling system as claimed in claim 17, wherein at least one of the sealing collars of the first and second trunk line connectors comprises a circumferential annular seal for sealing against the sealing collar of the complementary trunk line connector.

19. A method for wiring the alternating current end of a plurality of photovoltaic modules equipped with module inverters using the alternating current cabling system as claimed in claim 1, comprising the steps of:
equipping the photovoltaic modules with module inverters;
connecting a respective one of the cable modules to each module inverter of a photovoltaic module, by means of the drop cables;
delivering the prepared photovoltaic modules while the cable modules are provided with shipping caps on both ends thereof, for protection against dirt and moisture;
installing the prepared photovoltaic modules;
removing the shipping caps from the cable modules not yet interconnected;
interconnecting the not yet interconnected cable modules and thereby establishing the alternating current trunk line;
sealing the blind trunk line connector of the alternating current trunk line by means of the associated end cap; and
connecting the alternating current trunk line to the electrical grid using a grid connector.

20. A photovoltaic generator comprising a plurality of photovoltaic modules, at least some of which have a module inverter, wherein the module inverters are wired by means of the alternating current cabling system as claimed in claim 1.

21. A modular connector system comprising pluggable cable components for on-site interconnection of an alternating current cabling system of a photovoltaic generator that comprises a plurality of photovoltaic modules equipped with module inverters, the alternating current cabling system comprising an alternating current trunk line and drop cables connected thereto for feeding the alternating current from the plurality of module inverters into the common alternating current trunk line, so that the alternating current trunk line can be installed spaced from the module inverters, in particular according to claim 1, comprising:
a plurality of similar pre-assembled cable modules, each of the pre-assembled cable modules comprising the following components:
a male and a female trunk line connector;
a trunk line cable section connecting the male and female trunk line connectors; and
a drop cable electrically connected to the trunk line cable section;
wherein any number of cable modules can be plugged together serially by means of the male and female trunk line connectors to form a chain of a desired length, so that the trunk line cable sections serially connected in this manner form the alternating current trunk line, and so that the module inverters are connectable to the alternating current trunk line by means of the respectively associated drop cable; and
wherein one cable end of each of the drop cables is directly connected and hardwired to one of the first or second trunk line connectors of the associated cable module.

22. The modular connector system as claimed in claim 21, further comprising, for each alternating current trunk line to be connected:
a male end cap which can be fitted to the female trunk line connector to seal it during operation of the photovoltaic generator; or
a female end cap which can be fitted to the male trunk line connector to seal it during operation of the photovoltaic generator.

23. The modular connector system as claimed in claim 22, in addition to the end caps further comprising, for each of the cable modules:
a male shipping cap which can be fitted to the female trunk line connector to close it when being transported; and
a female shipping cap which can be fitted to the male trunk line connector to close it when being transported.

24. The modular connector system as claimed in claim 1, wherein the first trunk line connectors have locking tabs which are latchable with corresponding locking projections of the respective mating second trunk line connector, or vice versa; and
wherein the modular connector system comprises a release tool by means of which the locking engagement can be released.

25. The modular connector system as claimed in claim 24, wherein the shipping caps are manually removable from the trunk line connectors without a special tool; and/or wherein the male and female end caps have locking tabs and locking projections, respectively, which can be latched with the corresponding locking projections or locking tabs of the associated trunk line connector, and wherein the locking engagement is releasable using the release tool.

26. A connector system comprising mateable male and female photovoltaic connectors, in particular trunk line connectors as claimed in claim 1, and a release tool;
wherein the male and female photovoltaic connectors each comprise a dielectric housing having a plug-in face with metal terminal contacts for mating interconnection with the complementary metal terminal contacts of the complementary photovoltaic connector;
wherein the dielectric housing of one of the pair of male and female photovoltaic connectors has a locking projection on either lateral side of the plugin face;
wherein the dielectric housing of the complementary photovoltaic connector has a locking tab on either lateral side of the plug-in face, which is latchable with the locking projection in order to lock the interconnection between the male and female photovoltaic connectors in their mated state;
wherein the dielectric housing of the male or female photovoltaic connector has a groove extending transversely to the mating direction at a lateral side behind the locking projection or locking tab;
wherein the release tool is substantially U-shaped having two side flanks and a base connecting the two side flanks;
wherein the two side flanks of the release tool have a release post extending from the base transversely thereto;
wherein the release tool is fittable to the mated and latched male and female photovoltaic connectors transversely to the mating direction, wherein in the fitted state the release post is placed between the respective locking tab and a housing portion thereby biasing the respective locking tab away from the complementary locking projection so that the locking engagement of the interconnection between the male and female photovoltaic connectors is released to an extent so that the two mated photovoltaic connectors can be pulled apart manually.

27. The connector system as claimed in claim 26, wherein the release posts and the housing of the male or female photovoltaic connector have mutually complementary latching means which are adapted to retain the release tool on one of the two photovoltaic connectors while the two mated photovoltaic connectors are pulled apart.

28. The connector system as claimed in claim 1, wherein the complementary latching means are defined by a groove in the release post extending transversely to the release post, and by a bead on the housing of one of the photovoltaic connectors extending transversely to the release post, or vice versa.

29. A cable module, comprising
a first and a second trunk line connector;
a trunk line cable section connecting the first and second trunk line connectors; and
a drop cable electrically connected to the trunk line cable section;
wherein by means of its first and second trunk line connectors the cable module is serially connectable with further cable modules to form a chain, so that the trunk line cable sections serially connected in this manner together form the alternating current trunk line;
wherein by means of the drop cable a module inverter of a photovoltaic module is connectable to the alternating current trunk line; and
wherein one wire end of the drop cable is directly connected and hardwired to one of the first or second trunk line connectors of the cable module, with at least three electrical wires; and
wherein the other wire end of the drop cable is directly connectable to the module inverter by means of the at least three electrical wires.

30. A photovoltaic module in delivery state, comprising
a peripheral stabilizing frame projecting from the back of the photovoltaic module facing away from the sun;
a connection and junction box mounted to the back;
the connection and junction box and mounted to the back of the photovoltaic module, for transforming the electric direct current of the photovoltaic module into electric alternating current;
and a cable module as claimed in claim hardwired to the module inverter or connectable thereto by means of a connector;
wherein the module inverter has an installation height that does not extend beyond the peripheral stabilizing frame; and
wherein the cable module has an installation height that does not extend beyond the peripheral stabilizing frame.
